(19) United States
(12) Patent Application Publication
(10) Pub. No.: US 2018/0260752 A1
(43) Pub. Date: Sep. 13, 2018

(54) METHOD AND SYSTEM FOR DYNAMIC RESOURCE MANAGEMENT IN CONTENT DELIVERY SYSTEM

(71) Applicant: WIPRO LIMITED, Bangalore (IN)

(72) Inventors: Manish Verma, Bangalore (IN); Santosh Agarwal, Bangalore (IN)

(21) Appl. No.: 15/467,119

(22) Filed: Mar. 23, 2017

(30) Foreign Application Priority Data
Mar. 9, 2017 (IN) 201741008303

(51) Int. Cl. G06Q 10/06; G06Q 10/08

(52) U.S. Cl. CPC G06Q 10/06311; G06Q 10/083

(57) ABSTRACT

The present disclosure relates to a method and system for dynamic resource management in content delivery system by resource management system. The resource management system identifies task list for each of plurality of containers associated with content delivery system based on pre-defined factors, where task list comprises information of assignments appointed to each of container, monitor plurality of parameters associated with the plurality of containers, engaged in carrying out assignments, at pre-defined time intervals, where plurality of containers is routed based on pre-defined route and determine container from plurality of containers for delivery of new content based on monitoring, details associated with delivery of new content and amount of route deviation from pre-defined route by container for delivery of new content for dynamic resource management in content delivery system. The disclosure reduces overall delivery time of new content without having major impact on existing deliveries.

### TECHNICAL FIELD

The present subject matter is related in general to resource management, more particularly, but not exclusively, to a method and system for dynamic resource management in content delivery system.

### BACKGROUND

With rapid advancement in computing technology, e-commerce has gained huge popularity on the Internet. With advancement in e-commerce systems, performance of delivery systems in delivering contents play a major role in managing the e-commerce business. However, today, effective management and utilization of resources in the delivery system is still challenging.

In the current delivery systems, the last mile delivery is handled in a pre-planned manner, where a certain number of assignments are identified for delivery based on a region and delivery personnel is identified and assigned with those deliveries. Post all the deliveries, a delivery personnel may return to a hub and the next set of deliveries will be allocated. This results in sub-optimal use of resources. For instance, one branch office of a delivery system has multiple delivery hubs and each hub have several delivery personnel. A delivery assignment of 100 Kilograms is assigned to a delivery personnel, and after two deliveries, 50 kilograms' capacity is available and the delivery personnel is near one of the hub which has some deliveries to be made. In the current system, the delivery personnel in such case is not made available to take the assignment from the hub even though the delivery personnel is present very near to the hub location. This may cause sub-optimal utilization of the delivery personnel resource. Thus, the current delivery systems may not efficiently manage and utilize the resources.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for dynamic resource management in content delivery system, the method comprising identifying a task list for each of a plurality of containers associated with a content delivery system based on pre-defined factors. The task list comprises information of assignments appointed to each of the containers. The method comprising monitoring a plurality of parameters associated with the plurality of containers, engaged in carrying out the assignments, at pre-defined time intervals. The plurality of containers is routed based on a pre-defined route and determining a container from the plurality of containers for delivery of a new content based on the monitoring, details associated with delivery of the new content and amount of route deviation from the pre-defined route by the container for delivery of the new content for dynamic resource management in the content delivery system.

In an embodiment, the present disclosure relates to a resource management system for dynamic resource management in content delivery system. The resource management system comprises a processor and a memory communicatively coupled to the processor, wherein the memory stores processor executable instructions, which, on execution, may cause the resource management system to identify a task list for each of a plurality of containers associated with a content delivery system based on pre-defined factors. The task list comprises information of assignments appointed to each of the containers. The resource management system monitors a plurality of parameters associated with the plurality of containers, engaged in carrying out the assignments, at pre-defined time intervals. The plurality of containers is routed based on a pre-defined route and determine a container from the plurality of containers for delivery of a new content based on the monitoring, details associated with delivery of the new content and amount of route deviation from the pre-defined route by the container for delivery of the new content for dynamic resource management in the content delivery system.

In an embodiment, the present disclosure relates to a non-transitory computer readable medium including instructions stored thereon that when processed by at least one processor may cause a resource management system to identify a task list for each of a plurality of containers associated with a content delivery system based on pre-defined factors. The task list comprises information of assignments appointed to each of the containers. The instruction causes the processor to monitor a plurality of parameters associated with the plurality of containers, engaged in carrying out the assignments, at pre-defined time intervals. The plurality of containers is routed based on a pre-defined route and determine a container from the plurality of containers for delivery of a new content based on the monitoring, details associated with delivery of the new content and amount of route deviation from the pre-defined route by the container for delivery of the new content for dynamic resource management in the content delivery system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates an exemplary environment for dynamic resource management in content delivery system in accordance with some embodiments of the present disclosure;

FIG. 1b illustrates a block diagram of a container in accordance with some embodiments of the present disclosure;

FIG. 1e shows an exemplary representation of a resource management system in accordance with some embodiment of the present disclosure;

FIG. 2 shows a detailed block diagram of a resource management system in accordance with some embodiments of the present disclosure;

FIG. 3 shows an exemplary representation of dynamic resource management in content delivery system in accordance with some embodiments of the present disclosure;

FIG. 4 illustrates a flowchart showing a method for dynamic resource management in content delivery system in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure may relate to a method and a resource management system for dynamic resource management in content delivery system. In an embodiment, the content delivery system may comprise a plurality of hubs located at different locations. In an embodiment, the resource management system may be present in the plurality of hubs. In an embodiment, the content delivery system may include any e-commerce systems. In an embodiment, the resources associated with the content delivery systems may include human resource, such as, delivery personnel and the like. The content delivery system may comprise several contents to be delivered to users. To manage time of the delivery personnel of the content delivery system dynamically, a task list may be identified, which may comprise details of assignments to be appointed to various containers. In an embodiment, containers may be any transporting vehicles associated with the content delivery system. In an embodiment, the containers may include various sensors. The containers may be used by the resources for delivery of the assignments based on respective task list and follow a pre-defined route for delivery. In an embodiment, the resource management system may determine an optimal route for each container to deliver the contents in the task list based on one or more business rules. The business rules may include, but are not limited to, historical analytic data, shipping location, grouping on delivery shipping location, number, weight and size of items to be delivery and the like. Once the containers are routed, a plurality of parameters associated with the containers may be monitored at pre-defined intervals of time. In case, when a new assignment arises, a container may be determined which may perform the task of delivering contents associated with the new assignment. In an embodiment, delivering contents may include picking the contents from a nearest hub of the content delivery system and delivering to associated user. The container may be determined based on the monitoring of the parameters of plurality of containers and amount of route deviation which the containers may take for delivery of the new assignment, without affecting delivery of the previous assignments in the list. Thus, the present invention provides an effective utilization of the available resources and timely deliveries of both the existing and new assignments.

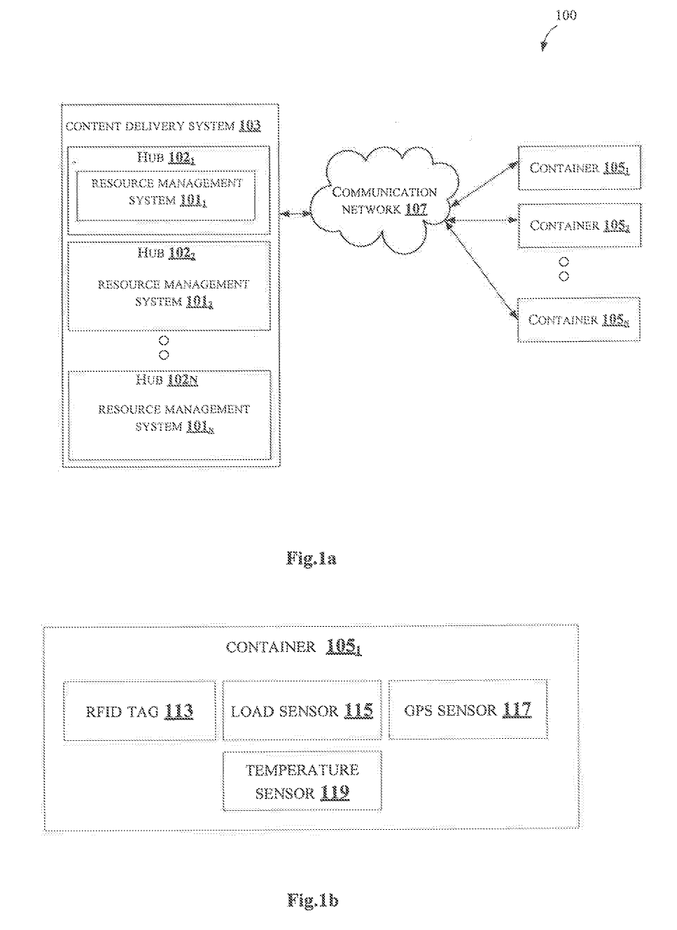

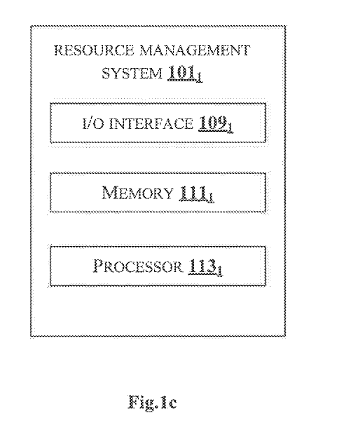

FIG. 1a illustrates an exemplary environment for dynamic resource management in content delivery system in accordance with some embodiments of the present disclosure.

As shown in FIG. 1a, the environment 100 comprises a content delivery system 103 connected through a communication network to a container 105₁, a container 105₂ . . . and a container 105_{N} (collectively referred as plurality of containers 105). The communication network 107 may include, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. In an embodiment, the content delivery system 103 may refer to e-commerce applications used for providing services to users. The users may order any content from the content delivery system 103. In an embodiment, the plurality of containers 105 may be associated with the content delivery system 103. In an embodiment, the plurality of containers 105 may be used for delivering the contents ordered by the users. In an embodiment, the plurality of containers 105 may be specific to a content delivery system 103. In an embodiment, the plurality of containers 105 may refer to a vehicle such as a truck, a tempo and the like for delivering the contents. Further, the content delivery system 103 comprises a hub 102₁, a hub 102₂, . . . and a hub 102_{N} (collectively referred as plurality of hubs 102). The plurality of hubs 102 may be located at different locations. The plurality of hubs 102 may be communicatively connected to each other. In an embodiment, the plurality of hubs 102 may be connected to each other through a communication network (not shown in FIG. 1a). In an embodiment, the plurality of hubs 102 may comprise contents to be picked and delivered to users. Further, the hub 102₁ comprises a resource management system 101₁ as shown in FIG. 1a. Similarly, the hub 102₂, . . . the hub 102_{N} may comprise respective resource management systems. The resource management systems of the plurality of hubs 102 may be collectively referred as resource management system 101 of the plurality of hubs 102. In an alternate embodiment, a resource management system may be connected to the plurality of hubs 102 of the content delivery system 103. The resource management system 101 of the plurality of hubs 102 dynamically manage resources of the content delivery system 103. In an embodiment, the resource management system 101 of the plurality of hub 102 may include, but is not limited to, a laptop, a desktop computer, a Personal Digital Assistant (PDA), a notebook, a smartphone, a tablet and any other computing devices. Further, in an embodiment, the content delivery system 103 may comprise a warehouse (not shown in FIG. 1) which may store the contents requested by the users. The contents requested by the users may be further transferred to one of a hub of the plurality of hubs 102 located in proximity of location of the users. Initially, say every day, the resource management system 101 of the plurality of hubs 102 may prepare a task list for that day for each of the plurality of containers 105 located in proximity to the corresponding plurality of hubs 102. The task list may include information about assignments appointed to each of the containers. The assignments may comprise delivery of the contents requested by the users. In an embodiment, the task list may comprise pickup and drop points and a pre-defined route for each of the container. The task list may be prepared based on pre-defined factors, which may include current location and capacity of container, time taken to traverse location at different time of a day and type of the container. A person skilled in the art would understand that any other factors not mentioned explicitly may also be used to prepare task list in the present disclosure. In an embodiment, the resource management system 101 may identify the pre-defined route for each of the plurality of containers 105 for delivering the contents associated with users. While the plurality of containers 105 may be engaged with the assignments allotted from the corresponding task list, the resource management system 101 of the plurality of hubs 102 may monitor a plurality of parameters associated with the plurality of containers 105 located near the plurality of hubs 102 at pre-defined time intervals. In an embodiment, the plurality of containers 105 may be configured with sensors as shown in FIG. 1b. FIG. 1b illustrates a block diagram of a container in accordance with some embodiments of the present disclosure. As shown in FIG. 1b, the container 105₁ may comprise a Radio Frequency identification (RFID) tag 113, a load sensor 115, a Global Positioning System (GPS) sensor 117 and a temperature sensor 119. Similarly, the container 105₂, . . . container 105_{N} comprises respectively sensors. A person skilled in the art would understand that the containers may also comprises other sensors which may track different characteristics of the containers in the present disclosure. In an embodiment, the RFID tag 113 may use electromagnetic fields to automatically identify and track tags attached to the contents. The RFID tag 113 may be used to track container 105₁ in real-time. The tag comprises electronically stored information. Particularly, the RFID tag 113 may track properties of the contents such as, size dimensions, weight, categories, sensitivity, deliver by time stamp, priority and the like. The information tracked by the RFID tag 113 of the container 105₁ may be stored in a central database (not shown in fig) of the content delivery system 103. The load sensor 115 in the container 105₁ may be used for tracking the current weight present on the container 105₁. The GPS sensor 117 of the container 105₁ may be utilized for tracking the location associated with the container 105₁. The temperature sensor 119 in the container 105₁ may be used for measuring the temperature of refrigerated containers.

Returning back to FIG. 1a, the plurality of parameters associated with the plurality of containers 105 may comprise tracking motion of container, characteristics of the contents in the container, current location of the container, percentage of contents loaded in the container and available capacity of each container. A person skilled in the art would understand that any other parameters not mentioned explicitly, may also be used for monitoring in the present disclosure. In an embodiment, the plurality of containers 105 may be routed based on the pre-defined route while performing the delivery of the contents. Further, whenever a request for delivering a new content appears in any of the plurality if hubs 102, the resource management system 101 of the respective hub, may determine a container from the plurality of containers 105 for delivering of the new content. The container may be determined based on the monitoring of the plurality of parameters of the plurality of containers 105, details associated with delivery of the new content and amount of route deviation from the pre-defined route by the container for delivery of the new content. In an embodiment, the details associated with the delivery of the new content comprises pickup location of the new content, drop location of the new content, type of the content, size and weight of the new content, delivery priority associated with the new content and time duration required to reach the pickup and drop location. Further, the resource management system 101 of the plurality of hubs 102 may identify a route for the container for the delivery of the new content based on current location of the container, characteristics of the route, time taken to traverse the location associated with the delivery of the new content at different time of a day. In a non-limiting embodiment, the route characteristics may include details of the delivery location, road/area flooding information, road blockage, security delays, temperature details during various time of the day and the like. In an embodiment, in case the containers from the plurality of containers 105 of a hub are not available, the hub may interact with other plurality of hubs 102 requesting for a container for performing the assignment of the new content. While requesting for the container, the hub may provide the details associated with the delivery of the new content to the other plurality of hubs 102.

FIG. 1c shows an exemplary representation of a resource management system in accordance with some embodiments of the present disclosure. FIG. 1c shows the resource management system 101₁. The resource management system 101₁ may comprise an I/O Interface 109₁, a memory 111₁, and a processor 112₁. Similarly, the resource management system 101₂, . . . resource management system 101_{N} may comprise respective I/O interfaces, memory and processors. The I/O interfaces of the plurality of hubs 102 may be collectively referred as interfaces 109. The memory of the plurality of hubs 102 may be collectively referred as memory 111 and the processor of the plurality of hubs 102 may be collectively referred as processor 113. The I/O interfaces 109 may be configured to receive details associated with delivery of contents from the content delivery system 103.

The received information from the I/O interfaces 109 may be stored in the memory 111. The memory 111 is communicatively coupled to the processors 112 of the resource management system 101 of the plurality of hubs 102. The memory 111 may also store processor instructions which cause the processors 112 to execute the instructions for dynamic resource management in content delivery system 103.

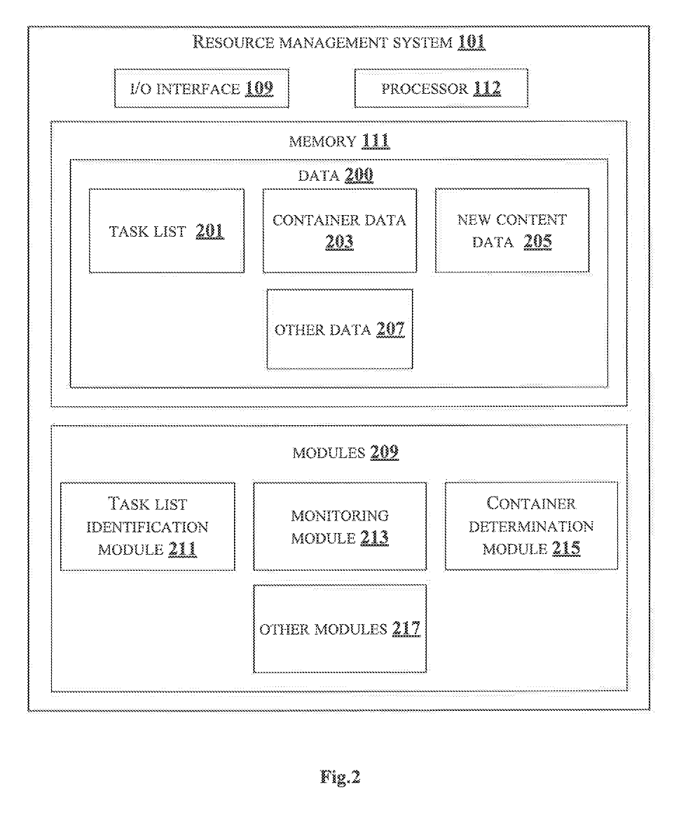

FIG. 2 shows a detailed block diagram of a resource management system in accordance with some embodiments of the present disclosure.

Data 200 and one or more modules 209 of the resource management system 101 of the plurality of hubs 102 are described herein in detail. In an embodiment, the data 200 comprises task list 201, container data 203, new content data 205 and other data 207.

The task list 201 may comprise details about assignments appointed to each of the plurality of containers 105. The details may include number of assignments, pickup location of the contents to be delivered, drop location of each of the contents, type of the contents, size and weight of the contents, delivery priority associated with the contents and time duration required to reach the pickup and each of drop location. In an embodiment, the pickup location may either be the hub where the content is present or the customer's location from where the content is required to be picked. The task list 201 may also comprise pickup and drop points with the pre-defined route for each of the container. The task list 201 may be identified based on the pre-defined factors associated with each container, such as, current location and capacity of container, time taken to traverse location at different time of a day and type of the container.

The container data 203 may include details about the plurality of containers 105 being monitored. The container data 203 may comprise details of the plurality of parameters associated with each of the plurality of containers 105 including, but not limited to, tracking motion of the container, characteristics of the contents, current location of the container, percentage of contents loaded in the container and available capacity of each container.

New content data 205 may comprise details about new content being allocated to a container from the plurality of containers 105. The new content data 205 may comprise the details associated with the delivery of the new content such as, pickup location of the new content, drop location of the new content, type of the content, size and weight of the new content, delivery priority associated with the new content and a time duration required to reach at least the pickup location of the new content and the drop location of the new content.

The other data 207 may store data, including temporary data and temporary files, generated by the one or more modules 209 for performing the various functions of the resource management system 101.

In an embodiment, the data 200 in the memory 111 may be processed by the one or more modules 209 of the resource management system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules when configured with the functionality defined in the present disclosure will result in a novel hardware.

In one implementation, the one or more modules 209 may include, but are not limited to, a task list identification module 211, a monitoring module 213 and a container determination module 215. The one or more modules 209 may also comprise other modules 217 to perform various miscellaneous functionalities of the resource management system 101. It will be appreciated that such modules 209 may be represented as a single module or a combination of different modules.

The task list identification module 211 may identify a task list 201 for each of the plurality of containers 105 associated with the content delivery system 103. The task list 201 for each of the container may comprises details about the assignment allotted. In an embodiment, the resources such as delivery personnel may follow the task list to deliver the contents to the users. The task list identification module 211 may identify the task list 201 based on the pre-defined factors such as, current location and capacity of container, time taken to traverse location at different time of a day and type of the container. In an embodiment, the task list identification module 211 may also identify the pre-defined route for the plurality of containers 105 to deliver the content in the corresponding task list 201 based on predefined business rules. In an embodiment, the business rules may include, historical analytic data, dropping location, time-in-transit, grouping on delivery location, number, weight and size of content to be delivered and the like. The optimal pre-defined route may be identified based on real time data collected from containers, contents, route characteristics and from hubs.

The monitoring module 213 may monitor the plurality of parameters associated with the plurality of containers 105. The monitoring module 213 may track the container motion at pre-defined time intervals, percentage load in the container, current location of the container and available capacity of the container in real time. The monitoring module 213 may also tracks each container's transit from a pickup location to drop location and provides time-stamps and GPS location.

The container determination module 215 may determine the container from the plurality of containers whenever any new content arrives for delivery. The container determination module 215 may determine the container based on the plurality of parameters monitored, details associated with the delivery of the new content and amount of route deviation from the pre-defined route by the container for delivery of the new content. In an embodiment, the container determination module 215 may determine the capacity of the plurality of containers 105 after each delivery point. Further, the container determination module 215 may determine the container based on the pre-defined threshold value for allowed route deviation in the pre-defined route depending on priority. In an embodiment, the priority may be based on perishable goods, privilege customer, and the like.

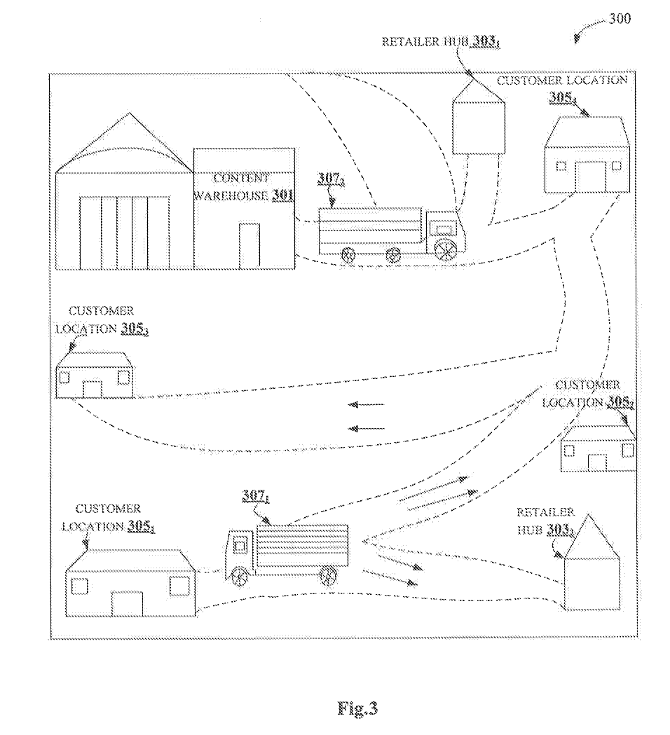

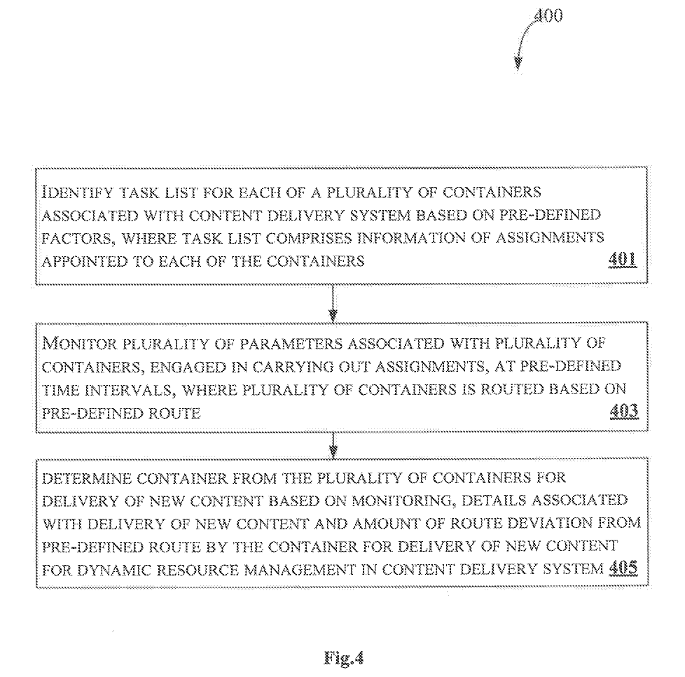

FIG. 3 shows an exemplary representation of dynamic resource management in content delivery system in accordance with some embodiments of the present disclosure.

As shown in FIG. 3, the environment 300 illustrates a scenario of delivering content to users in an exemplary embodiment of the present disclosure. The environment 300 may comprise a content warehouse 301 of a content delivery system 103, a retailer hub 303₁ and a retailer hub 303₂ associated with the content delivery system 103. A person skilled in the art would understand that FIG. 3 is an exemplary embodiment and the present disclosure may also include plurality of retailer hubs. In an embodiment, the content warehouse 301 may comprise plurality of contents from a manufacturing unit. The users of the content delivery system 103 may place an order at a website of the content delivery system 103. The content associated with the order may be stored in the content warehouse 301 of the content delivery system 103. In an embodiment, the contents from the content warehouse 301 may be further provided to different retailer hubs depending on the location of the user. The environment 300 may also comprise a container 307₁ and a container 307₂ associated with the content delivery system 103, a customer location 305₁, a customer location 305₂ and a customer location 305₃. In a first embodiment, initially the retailer hub 303₂ may identify a task list for the container 307₁ which is located near to the retailer hub 303₂ The task list of the container 307₁ comprises picking the contents from retailer hub 303₂ and delivering to the user of user location 305₁ and the user of user location 305₃. Suppose, a user at a user location 305₂ may place a request for an order to be delivered at the user location 305₂. In an embodiment, the content associated with the order may be provided from the content warehouse 301 of the content delivery system 103 to the retailer hub 303₂ as the retailer hub 303₂ is nearest from the user location 305₂. Further, the resource management system 101 of the retailer hub 303₂ monitors the parameters associated with the container 307₁. In an embodiment, the new content to be delivered to the user location 305₂ is a perishable good and requires to be kept at a particular temperature. Based on the monitoring of the parameters of the container 307₁, the resource management system 101 of the retailer hub 303₂ identifies that the current location of the container 307₁ is near to both the retailer hub 303₂ from where the content is required to be picked and the user location 305₂ where the content is required to be delivered. In addition, the container 307₁ comprises the unit to store the new content at a particular temperature. Further, the container 307₁ also comprises space for keeping the new content from the retailer hub 303₂. In an embodiment, the resource management system 101 of the retailer hub 303₂ may determine the amount of route deviation the container 307₁ may take to pick and deliver the content at the user location 305₂. The container 307₁ in the present example, may deviate from the route of the user location 307₃ which may be within a pre-defined threshold value. Further, based on the monitoring, the resource management system 101 of the retailer hub 305₂ determines that the container 307₁ may pick up the content associated with user location 305₂ after delivering the content of the user at user location 305₁ as shown in FIG. 3. In a second embodiment, initially, a user at user location 305₄ may place a request for an order to be delivered at the user location 305₁. The content associated with the order may be provided from the content warehouse 301 of the content delivery system 103 to the retailer hub 303₁ as the retailer hub 303₁ is nearest from the user location 305₄ Once the content is provided to the retailer hub 303₁, the resource management system 101 of the retailer hub 303₁ (not shown explicitly in FIG. 3) may identify a task list for the container 307₂ which is located near to the retailer hub 303₁. The task list of the container 307₂ may be identified based on the capacity and type of the container 307₂. Based on the availability of the container 307₂ from the task list, the resource management system 101 of the retailer hub 303₁ allots the delivery of the content. Further, the resource management system 101 of the retailer hub 303₁ may also provide the pre-defined route to a delivery personnel of the container 307₂ for delivering the content to the user of user location 305₄. Further, the container 307₁ located in proximity to the retailer hub 303₂ is allotted with the delivery of content associated with user location 305₁ and user location 305₃ based on the capacity, availability and type of the container. While the container 307₁ is routed for the user location 305₁, the resource management system 101 of the retailer hub 303₂ receives a new delivery assignment for the user location 305₂. In an embodiment, the new content to be delivered to the user location 305₂ may be a perishable good and requires to be kept at a particular temperature. The resource management system 101 of the retailer hub 303₁ monitors the parameters associated with the container 307₁ and identifies that the container 307₁ may not be available. In such case, the retailer hub 303₂ may request and check for a container with the retailer hub 303₁ for delivering the new content to the user location 305₂. Since the container 307₂ is available after the delivery of the content associated with user location 305₄, the retailer hub 303₁ may provide the details associated with the container 307₂ to the retailer 303₂. Based on the details, the retailer hub 303₂ allocates the delivery of the new content associated with the user location 305₂ to the container 307₂. In addition, the container 307₂ may comprise the unit to store the new content at a particular temperature. Further, the container 307₂ may also comprise space for keeping the new content from the retailer hub 303₂. The container 307₂ picks the new content from the retailer hub 303₂ and delivers to the user location 303₂.

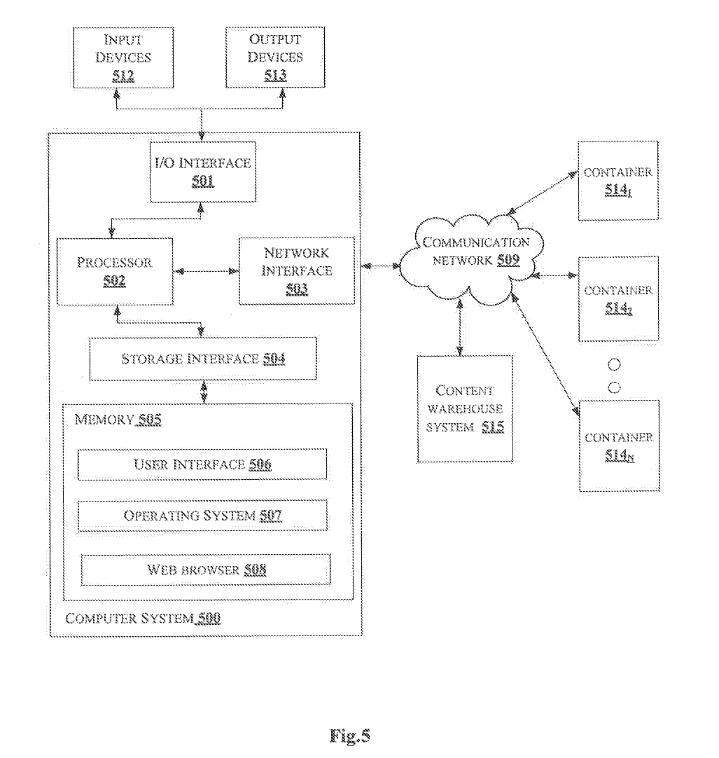

FIG. 4 illustrates a flowchart showing a method for dynamic resource management in content delivery system in accordance with some embodiments of present disclosure.

As illustrated in FIG. 4, the method 400 may comprise one or more blocks for dynamic resource management in content delivery system 103. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, identifying by the task list identification module 211 the task list for each of the plurality of containers 105 associated with the content delivery system 103 based on the pre-defined factors. The task list may comprise information of assignments appointed to each of the containers.

At block 403, monitoring by the monitoring module 213 the plurality of parameters associated with the plurality of containers, 105 engaged in carrying out the assignments, at pre-defined time intervals. The plurality of containers 105 may be routed based on a pre-defined route.

At block 405, determining by the container determination module 215 the container from the plurality of containers 105 for delivery of the new content based on the monitoring, details associated with delivery of the new content and amount of route deviation from the pre-defined route by the container for delivery of the new content. The details associated with the delivery of the new content may comprise pickup location of the new content, drop location of the new content, type of the content, size and weight of the new content, delivery priority associated with the new content and time duration required to reach the pickup and drop location.

FIG. 5 illustrates a block diagram of an exemplary computer system 500 for implementing embodiments consistent with the present disclosure. In an embodiment, the computer system 500 is used to implement the resource management system 101 of the plurality of hubs 102. The computer system 500 may comprise a central processing unit (“CPU” or “processor”) 502. The processor 502 may comprise at least one data processor for dynamic resource management in content delivery system. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of a resource management system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with a content delivery system 515 and the container 514₁, a container 514₂ . . . and a container 515_{N}. The network interface 503 may employ connection protocols include, but not limited to, direct connect, Ethernet (e.g., twisted pair 10/100/1000 Base T), transmission control protocol/internet protocol (TCP/IP), token ring, IEEE 802.11 a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure efficiently manages resources of content delivery system in real-time.

An embodiment of the present disclosure reduces overall delivery time of any new assignment without having a major impact on the existing deliveries.

An embodiment of the present disclosure provides a cost-effective solution for delivering contents in delivery system.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”. “one or more embodiments”, “some embodiments”, and “one embodiment” mean “one or more (but not all) embodiments of the invention(s)” unless expressly specified otherwise.

The terms “including”. “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Resource management system of plurality of hubs |
| 102 | Plurality of hubs |
| 103 | Content delivery system |
| 105 | Plurality of containers |
| 107 | Communication network |
| 109 | I/O interface |
| 111 | Memory |
| 112 | Processors |
| 113 | RFID tag |
| 115 | Load sensor |
| 117 | GPS sensor |
| 119 | Temperature sensor |
| 200 | Data |
| 201 | Task list |
| 203 | Container data |
| 205 | New content data |
| 207 | Other data |
| 209 | Modules |
| 211 | Task list identification module |
| 213 | Monitoring module |
| 215 | Container determination module |
| 217 | Other modules |

What is claimed is:

1. A method for dynamic resource management in content delivery system, the method comprising
identifying, by a resource management system, a task list for each of a plurality of containers associated with a content delivery system based on pre-defined factors, wherein the task list comprises information of assignments appointed to each of the containers;
monitoring, by the resource management system, a plurality of parameters associated with the plurality of containers, engaged in carrying out the assignments, at pre-defined time intervals, wherein the plurality of containers is routed based on a pre-defined route; and
determining, by the resource management system, a container from the plurality of containers for delivery of a new content based on the monitoring, details associated with delivery of the new content and amount of route deviation from the pre-defined route by the container for delivery of the new content for dynamic resource management in the content delivery system.

2. The method as claimed in claim 1, wherein the resource management system is located within a plurality of hubs of the content delivery system.

3. The method as claimed in claim 2, wherein the plurality of hubs of the content delivery system interact with each other.

4. The method as claimed in claim 1, wherein the pre-defined factors comprises current location and capacity of container, time taken to traverse location at different time of a day and type of the container.

5. The method as claimed in claim 1, wherein the task list comprises pickup and drop points in the pre-defined route for each of the container.

6. The method as claimed in claim 1, wherein carrying out the assignments comprises at least one of picking the contents from a location and dropping the contents to a location.

7. The method as claimed in claim 1, wherein the plurality of parameters associated with the plurality of containers comprises tracking motion of container, current location of the container, percentage of contents loaded in the container and, characteristics associated with the contents and available capacity of each container.

8. The method as claimed in claim 1, wherein the details associated with the delivery of the new content comprises pickup location of the new content, drop location of the new content, type of the content, size and weight of the new content, delivery priority associated with the new content and time duration required to reach the pickup and drop location.

9. The method as claimed in claim 1 further comprising identifying a route for the container for the delivery of the new content based on current location of the container, characteristics of route, time taken to traverse the location associated with the delivery of the new content at different time of a day.

10. A resource management system for dynamic resource management in content delivery system, comprising:
a processor; and
a memory communicatively coupled to the processor, wherein the memory stores processor instructions, which, on execution, causes the processor to:
identify a task list for each of a plurality of containers associated with a content delivery system based on pre-defined factors, wherein the task list comprises information of assignments appointed to each of the containers;
monitor a plurality of parameters associated with the plurality of containers, engaged in carrying out the assignments, at pre-defined time intervals, wherein the plurality of containers is routed based on a pre-defined route; and
determine a container from the plurality of containers for delivery of a new content based on the monitoring, details associated with delivery of the new content and amount of route deviation from the pre-defined route by the container for delivery of the new content for dynamic resource management in the content delivery system.

11. The resource management system as claimed in claim 10, wherein the resource management system is located within a plurality of hubs of the content delivery system.

12. The resource management system as claimed in claim 11, wherein the plurality of hubs of the content delivery system interact with each other.

13. The resource management system as claimed in claim 10, wherein the pre-defined factors comprises current location and capacity of container, time taken to traverse location at different time of a day and type of the container.

14. The resource management system as claimed in claim 10, wherein the task list comprises pickup and drop points in the pre-defined route for each of the container.

15. The resource management system as claimed in claim 10, wherein the processor carries out the assignments by at least one of picking the contents from a location and dropping the contents to a location.

16. The resource management system as claimed in claim 10, wherein the plurality of parameters associated with the plurality of containers comprises tracking motion of container, current location of the container, percentage of contents loaded in the container and available capacity of each container.

17. The resource management system as claimed in claim 10, wherein the details associated with the delivery of the new content comprises pickup location of the new content, drop location of the new content, type of the content, size and weight of the new content, delivery priority associated with the new content and time duration required to reach the pickup and drop location.

18. The resource management system as claimed in claim 10, wherein the processor identifies a route for the container for the delivery of the new content based on current location of the container, characteristics of route, time taken to traverse the location associated with the delivery of the new content at different time of a day.

19. A non-transitory computer readable medium including instruction stored thereon that when processed by at least one processor cause a resource management system (101) to perform operation comprising:
identifying a task list for each of a plurality of containers associated with a content delivery system based on pre-defined factors, wherein the task list comprises information of assignments appointed to each of the containers;
monitoring a plurality of parameters associated with the plurality of containers, engaged in carrying out the assignments, at pre-defined time intervals, wherein the plurality of containers is routed based on a pre-defined route; and
determining a container from the plurality of containers for delivery of a new content based on the monitoring, details associated with delivery of the new content and amount of route deviation from the pre-defined route by the container for delivery of the new content for dynamic resource management in the content delivery system.

20. The medium as claimed in claim 19, wherein the resource management system is located within a plurality of hubs of the content delivery system.

21. The medium as claimed in claim 20, wherein the plurality of hubs of the content delivery system interact with each other.

22. The medium as claimed in claim 19, wherein the pre-defined factors comprises current location and capacity of container, time taken to traverse location at different time of a day and type of the container.

23. The medium as claimed in claim 19, wherein the task list comprises pickup and drop points in the pre-defined route for each of the container.

24. The medium as claimed in claim 19, wherein carrying out the assignments comprises at least one of picking the contents from a location and dropping the contents to a location.

25. The medium as claimed in claim 19, wherein the plurality of parameters associated with the plurality of containers comprises tracking motion of container, current location of the container, percentage of contents loaded in the container and, characteristics associated with the contents and available capacity of each container.

26. The medium as claimed in claim 19, wherein the details associated with the delivery of the new content comprises pickup location of the new content, drop location of the new content, type of the content, size and weight of the new content, delivery priority associated with the new content and time duration required to reach the pickup and drop location.

27. The medium as claimed in claim 19, wherein the instruction causes the processor to identify a route for the container for the delivery of the new content based on current location of the container, characteristics of route, time taken to traverse the location associated with the delivery of the new content at different time of a day.
